(19) United States
(12) Patent Application Publication
(10) Pub. No.: US 2013/0233885 A1
(43) Pub. Date: Sep. 12, 2013

(54) Young Coconut Insert

(71) Applicant: Claude Cohen, North Miami, FL (US)

(72) Inventor: Claude Cohen, North Miami, FL (US)

(21) Appl. No.: 13/416,121

(22) Filed: Mar. 9, 2012

(51) Int. Cl. B67D 1/00

(52) U.S. Cl. 222/91

(57) ABSTRACT

A young coconut insert that is used to deliver the contents of a young coconut in a hygienic and safe manner, the young coconut insert comprises of a needle like body, the needle like body having a top section, a middle section, and a bottom section, the bottom section of the needle like body defines an opening that will increase in diameter as it flows toward the top of the needle like body, the top section of the needle like body will define a receiver and a flange, and the middle section of the receiver will either be screw like or it will define wings that face upward from the bottom section of the needle like body. The young insert further comprises of a cap that is placed over the receiver. The young coconut insert may still further comprise of at least one tamper resistant seal. The tamper resistant seal may be placed over the cap of the insert or over the receiver prior to the placement of the cap.

### BACKGROUND

The present invention is directed toward an insert that is used to penetrate a young coconut. The insert could be screw like or nail like. The insert is used to extract the water from a young coconut using a straw or it may be able to be used without a straw, depending on the architecture of the insert.

The insert is needle like and will have a top and a bottom. The bottom of the needle will be similar to the tip of a needle in that it will be sharp enough to penetrate the shell or skin of the young coconut. After the insert is inserted within the young coconut, the needle will be held in place by screw ridges defined on the needle or at least one wing that faces upward from the tip of the needle. Each wing of the needle becomes a coconut hook that prevents the needle from being removed from the young coconut after insertion.

The insert may be made out of hard plastic, wood, ceramic, stainless steel, or any other material that will not contaminate the water inside the young coconut.

The present invention will allow coconut water to be sold without losing any of the natural nutrients of the water or contaminating the water within the young coconut.

The insert will be sealed using a cap. The cap could be screwed on the top of the insert or can be attached to the top of the cap.

A tamper seal can be placed on the top of the insert or on top of the cap to place the public on notice that after the insert has been inserted, the insert has not been tampered with.

### SUMMARY

The present invention is an insert that is used to deliver the contents of a young coconut in a hygienic and safe manner, the insert comprises of a needle like body, the needle like body having a top section, a middle section, and a bottom section, the bottom section of the needle like body defines an opening that will increase in diameter as it flows toward the top of the needle like body, the top section of the needle like body will define a receiver and a flange, and the middle section of the receiver will either be screw like or it will define wings that face upward from the bottom section of the needle like body. The insert further comprises of a cap that is placed over the receiver. The insert may still further comprise of at least one tamper resistant seal (not shown in drawing). The tamper resistant seal may be placed over the cap of the insert or over the receiver prior to the placement of the cap.

In one embodiment of the present invention, the needle like body will define at least one perforation so that any content within a coconut in which the insert is used can easily flow out of the coconut.

Ideally, the present invention would be sold with a disposable straw that could be placed within the insert after opening.

The insert of the present invention is used by either screwing or nailing the insert into a coconut. In its commercial use, the insert would be sealed to protect the public from any tampering.

An object of the present invention to allow a young coconut to be drained without having to cut the young coconut open.

A further object of the present invention is to prevent the liquid from the young coconut from being contaminated.

Still a further object of the present invention is to preserve all of the nutrients of a young coconut.

### DRAWINGS

These and other features, aspects, and advantages of the present invention will become better understood with regard to the following description, appended claims, and drawings where:

FIG. 1 shows a side plan view of the present insert, showing the insert within the shell of a young coconut;

FIG. 2 shows a side plan view of the present invention, wherein the middle section of the needle like body is screw like;

FIG. 3 shows a side plan view of the present invention, wherein the middle section of the needle like body is nail like; and

FIG. 4 shows a side plan view of the present invention, wherein the middle section of the needle like body defines perforations.

### DESCRIPTION

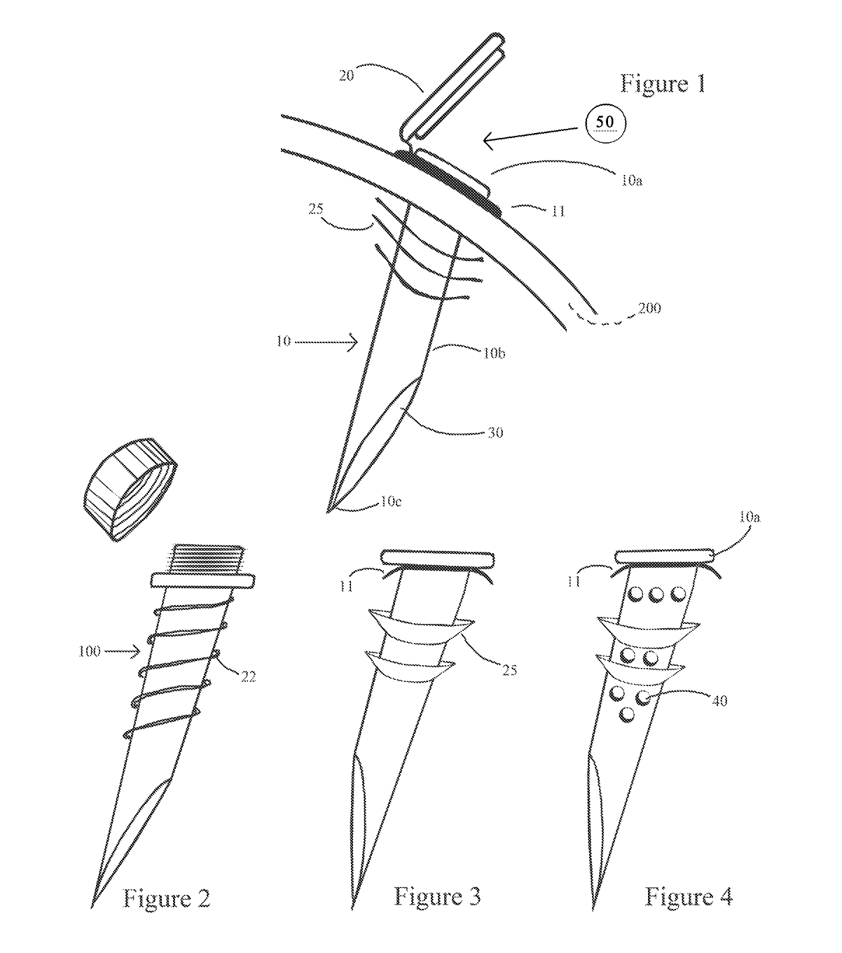

As seen in FIGS. 1-4, a young coconut insert 100 used for draining the liquid from within a young coconut 200 in a hygienic manner that will not contaminate any of the liquid within the young coconut 200, the young coconut insert 100 comprises of a tubular body 10 having a top 10a, a middle 10b and a bottom 10c, the bottom of the tubular body 10c is beveled and the top defines a receiver 10a, below the receiver 10a the tubular body 10 defines a curved flange 11 that curves toward the bottom of the tubular body 10c, the tubular body 10 further defines an anchor 22 or 25 that is between the curved flange 11 and the bottom of the tubular body 10c; and a cap 20, the cap 20 is removable and attaches to the receiver 10c.

In another embodiment of the present invention, the young coconut insert 100 further comprises of a tamper resistant seal 50, the tamper resistant seal 50 may be placed over the cap 20 after the cap 20 is attached to the receiver 10a or it may be placed over the receiver 10a prior to attaching the cap 20 to the receiver 10a.

In a further embodiment of the present invention, the tubular body of the young coconut insert 100 defines a plurality of apertures 40 through the length of the tubular body 10.

As seen in FIG. 2, the anchor of the present invention might be screw like 22 in one embodiment. In another embodiment, as seen in FIGS. 3 and 4, the anchor might be wing like.

In another embodiment of the present invention, as seen in FIG. 4, the tubular body 10 might define a plurality of apertures 40. The apertures 40 allow the users of the young coconut insert 100 to use the young coconut insert 100 to drain any liquid within the young coconut 200 without the need of a straw.

The present invention is used by inserting the beveled portion 10c of the young coconut insert 100 through the skin of a young coconut 200. The young coconut insert can be used with a straw or without. In a preferred embodiment, the young coconut insert 100 would be commercialized using the tamper resistant seal 50.

The present invention might be made of any of the following materials: plastic, ceramic, wood, bamboo, or stainless steel.

An advantage of the present invention is that it allows a young coconut to be drained without having to cut the young coconut open.

A further advantage of the present invention is that it prevents the liquid from the young coconut from being contaminated.

Still a further advantage of the present invention is that it preserves all of the nutrients of a young coconut.

Although the present invention has been described in considerable detail in reference to preferred versions, other versions are possible. Therefore, the spirit and scope of the appended claims should not be limited to the description of the preferred versions contained herein.

What is claimed is:

1. A young coconut insert used for draining the liquid from within a young coconut in a hygienic manner that will not contaminate any of the liquid within the young coconut, the young coconut insert comprises:
a tubular body having a top and a bottom, the bottom of the tubular body is beveled and the top defines a receiver, below the receiver the tubular body defines a first curved flange that curves toward the bottom of the tubular body, the tubular body further defines an anchor that is between the first flange and the bottom of the tubular body; and
a cap, the cap is removable and attaches to the receiver.

2. The young coconut insert of claim 1, further comprises of a tamper resistant seal, the tamper resistant seal may be placed over the cap after the cap is attached to the receiver or it may be placed over the receiver prior to attaching the cap to the receiver.

3. The young coconut insert of claim 2, wherein the tubular body defines a plurality of apertures through the length of the tubular body.

4. The young coconut insert of claim 3, wherein the anchor is screw like.

5. The young coconut insert of claim 4, wherein the tubular body is made of stainless steel.

6. The young coconut insert of claim 4, wherein the tubular body is made of plastic.

7. The young coconut insert of claim 4, wherein the tubular body is made of a ceramic material.

8. The young coconut insert of claim 4, wherein the tubular body is made of a wood material.

9. The young coconut insert of claim 4, wherein the tubular body is made of a bamboo material.

10. The young coconut insert of claim 3, wherein the anchor is wing like and the tips of the wings face toward the top of the tubular body.

11. The young coconut insert of claim 10, wherein the tubular body is made of stainless steel.

12. The young coconut insert of claim 10, wherein the tubular body is made of plastic.

13. The young coconut insert of claim 10, wherein the tubular body is made of a ceramic material.

14. The young coconut insert of claim 10, wherein the tubular body is made of a wood material.

15. The young coconut insert of claim 10, wherein the tubular body is made of a bamboo material.
